(19) United States
(12) Patent Application Publication
(10) Pub. No.: US 2009/0177686 A1
(43) Pub. Date: Jul. 9, 2009

(54) Method for Generating Database Installation Scripts

(75) Inventor: Gerard Doeswijk, Rotterdam (NL)

Correspondence Address: BROMBERG & SUNSTEIN LLP, 125 SUMMER STREET, BOSTON, MA, 02110-1618, US

(73) Assignee: INTERGRAPH SOFTWARE TECHNOLOGIES COMPANY, Las Vegas, NV (US)

(21) Appl. No.: 12/334,669

(22) Filed: Dec. 15, 2008

Related U.S. Application Data
(60) Provisional application No. 61/018,713, filed on Jan. 3, 2008.

(51) Int. Cl. G06F 17/30

(52) U.S. Cl. 707/103 R; 707/E17.055

(57) ABSTRACT

A method for generating automated scripts for installing objects into databases on database servers. A script generator inputs parameters such as the target database server identifier and a list of target databases for the installation. The script generator also inputs a hierarchical directory tree with files at the child nodes containing object installation instructions. The script generator traverses the directory tree, starting with the root node, and generates an installation script. The script generator can also input a time/date at which the installation script will be automatically executed, allowing for unattended operation of the object installation procedure. Thus, a database administrator is substantially shielded from the complexity of the installation process and installations can be standardized across multiple database servers and databases.

This application claims priority from U.S. provisional patent application, Ser. No. 61/018,713, filed Jan. 3, 2008, entitled “Method for Generating Database Installation Scripts”, atty docket 2686/134, which is incorporated by reference herein in its entirety.

### TECHNICAL FIELD

The present invention relates to methods of installing objects into databases on database management systems, and, in particular, to methods of generating automated object installation scripts.

### BACKGROUND

A computer database is a structured collection of records or data that is stored in a computer system. A computer program or person using a query language accesses the database to store/retrieve information. Computer databases that maintain a set of separate, related files (tables), but combine data elements from the files for queries and reports is known as a “relational database.” The Structured Query Language (“SQL”), an ANSI standard, is the standard query language for relational databases. SQL statements are used to perform tasks such as updating data or retrieving data from a database. The computer program used to manage and query a database is known as a database management system (“DBMS”).” A “database platform” refers to a type of DBMS, such as: MS SQL Server, Oracle, IBM DB2, Sybase, etc. A “database server” is the physical host for the DBMS.

Two major components exist within SQL for manipulating databases: Data Manipulation Language (“DML”) and Data Definition Language (“DDL”). DML is generally used to manage data within the database by means of statements such as SELECT, INSERT and UPDATE. DDL is used to create, modify or remove the structure of the objects contained within a database. A “database instance” is a specific installation of a database platform on a database server. Within a database instance is typically found one or more databases, i.e., a collection of tables, etc., defined by means of DDL

Data in relational databases are organized into tables. Tables are organized into rows and columns, containing data items. To populate a table with data, the table “object” must first be installed into the database. Installation of an object means defining the attributes of the object to the DBMS. Other types of objects can include: stored procedures, triggers, functions and views. All of these objects have in common that they are implemented in a relational database by means of object definitions.

Installation of objects into DBMSs can be accomplished by execution of a batch file containing a “script.” These scripts contain a definition of an object that is defined through a set of instructions, e.g., SQL commands, to the DBMS to install the object into a database. These object definitions would commonly be generated, or developed, by a database developer and can contain complex logic. Due to the complexity of these scripts, a skilled database administrator is needed to prepare (program) the scripts for implementation of the objects on a database server. Differences in the programmed scripts can lead to differences in the databases, even when the databases should contain the same objects, organized in the same fashion. Differences may exist, for instance, because of varying releases or variations that a database developer maintains.

### SUMMARY OF THE INVENTION

In an embodiment of the invention, a computer-based method for creating an installation script for installing a set of objects into a database on a database server is provided. This method includes receiving a set of inputs. The inputs include an identifier for the database platform, an identifier for the database server and database instance, an identifier for at least one database for the database instance, and authentication information for the database server and database. A location for the object definitions is also input. A hierarchical directory tree containing a root node and at least one child node is provided. Each node of the tree is associated with at least one object in the set of objects. Each node contains at least one installation file containing instructions for installing at least one object into at least one database on the database server. The method generates an installation file containing processor instructions for selecting the database server, selecting a specified database, and traversing each node of the directory tree including: executing the installation file for the at least one object associated with each node, thereby installing the at least one object into the specified database.

In a further embodiment of the invention, the installation file includes instructions for executing the object installation instruction files for each database in a plurality of database instances. In another embodiment of the invention, the installation file includes instructions to execute the installation at a specified date and time.

### BRIEF DESCRIPTION OF THE DRAWINGS

The foregoing features of the invention will be more readily understood by reference to the following detailed description, taken with reference to the accompanying drawings, in which:

FIG. 1 shows a computer equipment organization for use with an embodiment of the invention;

FIG. 2 shows the layout of a hierarchical directory tree containing object definition (DDL) instructions, for the embodiment of FIG. 1;

FIG. 3 is a flow diagram illustrating parameter input for the object installation generator program, according to an embodiment of the invention;

FIG. 4 shows an overall execution flow for the command scripts written by the object installation generator program, according to an embodiment of the invention; and

FIG. 5 is a flow chart, illustrating the steps executed by the object installation generator in preparing an automated script installing objects into databases, in an embodiment of the invention.

### DETAILED DESCRIPTION OF SPECIFIC EMBODIMENTS

In overview, various computer-based embodiments of this invention generate consistent, validated scripts for installing objects into databases. Execution of these scripts requires minimal database administrator interaction. The database developer that has developed the object scripts or a database administrator provides the inputs for an object installation generator (“OIG”) program. These inputs can include identifiers for the target database server, identifiers for the target databases, and authentication information, such as user ids and passwords. The developer provides a hierarchical directory tree with object installation files at each node of the tree. These object installation files contain computer processor instructions for installing each object into a target database. The generator program then generates instructions for an installation script for execution by the database server. These instructions select the database and database server for the installation. These instructions then execute the object installation files at each node of the tree. The script automatically executes these object installation instructions for each target database, if more than one database is specified in the input to OIG. Further, input to the generator program can optionally include a time of execution for the installation, so that unattended installation is provided. Generation of automated database installation scripts using OIG can advantageously lead to standardization of installed databases across multiple DBMSs. A significant reduction of the time and skill level of the administrator needed for the installations can also result.

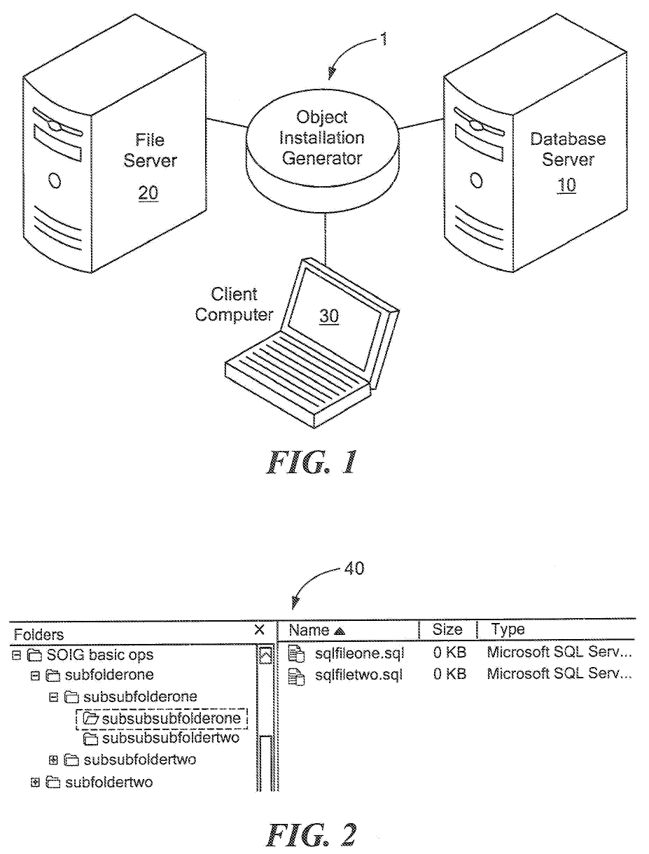

In an embodiment of the invention, in an illustrative equipment organization 1, a database server 10, as shown in FIG. 1, hosts one or more database instances with each instance containing one or more relational databases. The database management server program that runs on the database server 10 may respond to SQL commands, but, in other specific embodiments, the DBMS program can respond to other relational database command sets. A file server 20 stores an object installation hierarchical directory tree. This directory tree contains executable installation instructions for installing database objects into target databases. These instructions are contained in command files at each node of the tree. Each node of the tree can contain one installation file or a plurality of installation files and each installation file can contain the instructions for installing one object or a plurality of objects. Note that there is no limit on the depth of sub directories that can reside in this directory tree. FIG. 2 is a screenshot of an example of such a hierarchical directory tree 40 for a SQL object installation. In the screenshot, two object definition files are visible, “sqlfileone.sql” and “sqlfiletwo.sql,” each file containing a set of DDL instructions. These files correspond to objects to be installed, with the files containing installation instructions for each object. However, any of the subdirectories visible may contain such object installation files. The object installation files are identified by the file extension “sql” in this specific embodiment of the invention. Other extensions or means to identify object installation files may be employed.

The root node of the tree 40, in this case directory “SOIG BASIC OPS”, can also contain a file or files with the following information:
DBMS type;
username for the database administrator;
password for the database administrator;
target database server;
target database instance;
target database or list of databases for the installation; and optionally:
time and date at which the installation should occur.
   In specific embodiments, one or more of these parameters may default to a specified value and any of these parameters may be entered from a keyboard or other input device by the script developer.

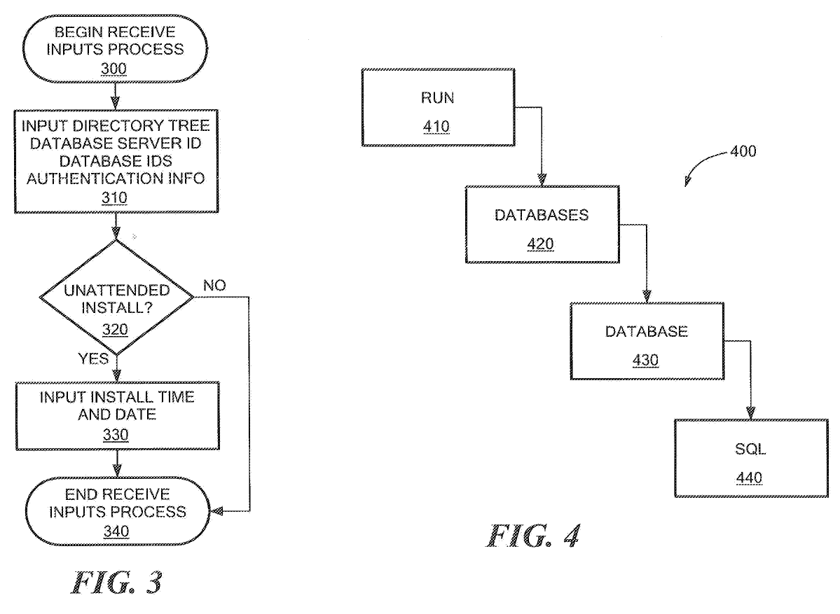

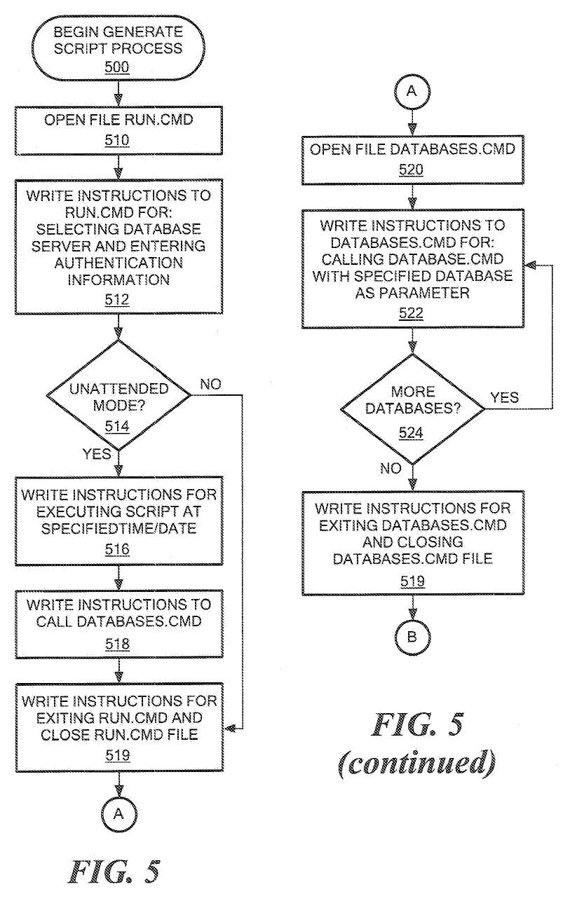

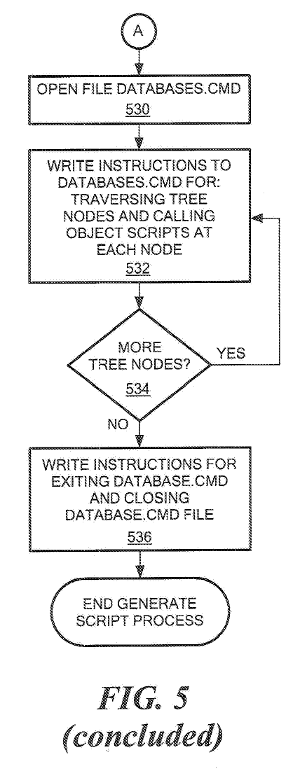

An object installation generator (“OIG”) program contains computer-executable instructions for generating installation scripts for installing the objects into the target databases, using the input information described above. OIG may run on a client computer (30 in FIG. 1) or as an application on the file server computer or on any other processor with suitable resources and access to the directory tree on the file server. As shown in FIG. 3 300, OIG inputs the above parameters from a file or other input medium 310. If the installation will be attended 320, the input process completes 340. Otherwise, the install time and date are input 330 and then the input process completes 340. OIG then generates a file with processor-executable instructions for installing the objects into the target databases, as shown below in FIG. 5. This file may then be executed by the database management server to install the objects into the target databases. Details are provided below.

OIG ensures that the installation script creator (or the database administrator who execute the scripts) need not be aware of the directory tree structure or the filenames of the object installation script files, when creating the installation script for the objects. OIG begins with the root directory and recursively traverses each child node of the directory tree. At each node, OIG determines the object installation instructions files present and generates instructions for the script to execute these object installation instructions. For example, object installation files can be identified by the OIG based on the provided input of the database platform and the related file extension eliminating the need for filenames to be known or even the need for the number of objects to be installed to be known. Thus, only the location of the root directory of the tree needs to be specified. Any installation that is generated by the OIG may be transferred out of the originating directory; that is a copy of the object definitions may be made prior to the creation of installation instructions for the object definitions. This is so that, if required, the directory used by the developer for storage of the object definitions is not contaminated with the additional install scripts that the OIG creates.

The script output by OIG 400, in this embodiment, is structured as shown in FIG. 4.
A run script 410 contains global variables such as login information for the database instance and the database server. The run script enters this login information and gains read/write access to the target databases on the database server. The run script then calls the databases script and, upon return, exits.
A databases script 420 contains a list of databases on which the objects are to be installed. The databases script calls the database script for each of the target databases and, upon return, exits.
A database script 430 contains instructions to traverse the directory tree and to call the object installation scripts found at the root node or any child nodes of the tree, and upon return, exits.
The object installation scripts 440 contain the commands for installing the actual objects on the target database server. These commands may comprise, for example, a series of SQL commands. These scripts are contained in the nodes of the tree.
Optionally, if a user provides a time and date as an input parameter to the OIG; the script creates a scheduled task on the target system, which will in turn launch the run script at the desired time (unattended mode).

FIG. 5 is a flow chart illustrating the execution flow of the OIG program 500 for generating the script files. (OIG has already input the parameters described above for the installation, as shown in FIG. 3). OIG then writes instructions to a file named “run.cmd 510.” These instructions select the database server and enter authentication information for the database and database server, such as user id and password 512. If the user has specified unattended mode 514, instructions are included to schedule execution of the installation scripts 516. OIG then writes instructions for executing command file “databases.cmd” 518 and then exiting the run.cmd script. The run.cmd file is then closed 519.

Next, OIG writes instructions to a file named “databases.cmd 520.” These instructions call a command file called “database.cmd,” passing the name of a database from the list of databases to the command file, as a parameter 522. Instructions for each database in the list of databases are written in turn 524. An instruction to exit the command file is then written and the database.cmd file is closed 526.

Next, OIG writes instructions to a file named “database.cmd 530.” OIG traverses the directory tree 532 and writes instructions for executing one or more object installation files located at each tree node, after changing the current directory pointer appropriately 534. When each node has been traversed, OIG writes an instruction to exit database.cmd and closes the database.cmd file 536.

When the installation script files are executed, the database server will require access to the information contained in the hierarchical directory tree. This access may be provided via a communication network to a file server containing the tree or the information may be provided on various types of media, as are known in the art.

Execution of the installation script files output by OIG at each database server advantageously provides a standardized installation of the objects into the database(s) while minimizing the human resources required.

The program flow and organization described above is intended to illustrate an embodiment of the invention. As will be apparent to those skilled in the art, other organizations and instruction sequences can be developed for the installation script file generator without departing from the true nature of the invention, as described above and in the appended claims. All such organizations and instruction sequences are intended to be within the scope of this invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the logic is implemented as a set of computer program instructions that is converted into a computer executable form, stored as such in a computer readable medium, and executed by a processor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may also be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention, as described in the appended claims. The described embodiments are to be considered in all respects only as illustrative and not restrictive.

What is claimed is:

1. A computer-implemented method for creating an installation script for installing a set of objects into a database in a database instance on a database server, comprising:
receiving input including:
an identifier for a database platform,
an identifier for the database server,
an identifier for the database instance,
an identifier for the database, and
a hierarchical directory tree, each node of the tree associated with at least one object in the set of objects, each node containing an installation file containing installation instructions for the at least one object associated with the node;
generating an installation file containing processor instructions for:
selecting the database server,
selecting the database instance,
selecting the database, and
traversing each node of the directory tree including:
executing the installation file for the at least one object associated with each node, thereby installing the at least one object into the database.

2. A method according to claim 1, wherein:
receiving input includes receiving input identifying at least one additional database in the database instance with associated hierarchical directory tree thereby forming a plurality of databases and wherein generating an installation file containing processor instructions further includes generating instructions for:
selecting a specified database for each database in the plurality of databases in turn and then traversing each node of the corresponding directory tree including:
executing the installation file for each object associated with the node thereby installing the object into the specified database.

3. A method according to claim 1, wherein:
receiving input further includes receiving input describing a specified time of execution of the installation script and wherein
generating an installation file containing processor instructions further includes generating instructions for executing the installation file at the specified time.

4. A method according to claim 1, wherein:
receiving input further includes receiving input including authentication information for the database and wherein
generating an installation file containing processor instructions further includes generating instructions for:
authenticating access to the database.

5. A method according to claim 1, wherein:
receiving input further includes receiving input including authentication information for the database server and wherein
generating an installation file containing processor instructions further includes generating instructions for:
authenticating access to the database server.

6. A computer program product for creating an installation script for installing a set of objects into a database in a database instance on a database server, the computer program product comprising a computer readable medium having computer readable program code stored thereon, the computer readable program code comprising program code for
receiving input including:
an identifier for a database platform,
an identifier for the database server,
an identifier for the database instance,
an identifier for the database, and
a hierarchical directory tree, each node of the tree associated with at least one object in the set of objects, each node containing an installation file containing installation instructions for the at least one object associated with the node;
generating an installation file containing processor instructions for:
selecting the database server,
selecting the database instance,
selecting the database, and
traversing each node of the directory tree including:
executing the installation file for the at least one object associated with each node, thereby installing the at least one object into the database.

7. A computer program product according to claim 6, wherein:
receiving input includes receiving input identifying at least one additional database in the database instance with associated hierarchical directory tree thereby forming a plurality of databases and wherein generating an installation file containing processor instructions further includes generating instructions for:
selecting a specified database for each database in the plurality of databases in turn and then traversing each node of the corresponding hierarchical directory tree including:
executing the installation file for each object associated with the node thereby installing the object into the specified database.

8. A computer program product according to claim 6, wherein:
receiving input further includes receiving input describing a specified time of execution of the installation script and wherein
generating an installation file containing processor instructions further includes generating instructions for executing the installation file at the specified time.

9. A computer program product according to claim 6, wherein:
receiving input further includes receiving input including authentication information for the database and wherein
generating an installation file containing processor instructions further includes generating instructions for:
authenticating access to the database.

10. A computer program product according to claim 6, wherein:
receiving input further includes receiving input including authentication information for the database server and wherein
generating an installation file containing processor instructions further includes generating instructions for:
authenticating access to the database server.

11. A computer program product comprising a computer readable medium having an encoded data structure stored thereon, the data structure comprising a hierarchical branching tree, the tree including a root node containing a database identifier and a database server identifier, the tree further containing at least one child node descending from the root node, the at least one child node containing at least one instruction file, the at least one instruction file containing program instructions for installing at least one object into a database on a database server, the at least one instruction file identified by a filename with a specified extension, the specified extension for identifying the file as an object installation instruction file.

12. A computer program product according to claim 11, wherein the at least one instruction file includes instructions for installing a plurality of objects.
